(19) United States
(12) Patent Application Publication
(10) Pub. No.: US 2008/0225905 A1
(43) Pub. Date: Sep. 18, 2008

(54) APPARATUS, METHOD AND PROGRAM FOR IMAGE FORMING

(75) Inventors: Yuji Inagawa, Numazu-shi (JP); Koji Tanimoto, Tagata-gun (JP); Kenichi Komiya, Kawasaki-shi (JP); Daisuke Ishikawa, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/685,415

(22) Filed: Mar. 13, 2007

(51) Int. Cl. H01S 3/10

(52) U.S. Cl. 372/24

(57) ABSTRACT

An image forming apparatus includes a scanning unit that deflects and scans a laser beam emitted from a laser beam source, an optical system that guides the laser beam onto a photoconductive drum, a storing unit that stores plural correction patterns that give a series of correction values for correcting an amount of laser beams in one scanning, a selecting unit that selects a correction group including at least two kinds of correction patterns out of the stored correction patterns, a switching unit that switches the at least two kinds of correction patterns belonging to the selected group at predetermined timing, a correcting unit that corrects, on the basis of the correction patterns switched by the switching unit, an amount of laser beams being scanned, and a printing unit that prints, on one medium, plural images formed on the photoconductive drum by laser beams corrected by the respective correction patterns.

### BACKGROUND OF THE INVENTION

1. Field of the Invention

The present invention relates to an image forming apparatus, an image forming method, and an image forming program that can control an increase in product cost and easily eliminate density unevenness.

2. Description of the Related Art

In general, in image forming apparatuses such as a digital copying machine in which a semiconductor laser (hereinafter referred to as “laser”) is used as a light source, a light amount control method called APC (Auto Power Control) is used. In the APC, a light emission amount of the laser in an image area is detected by a photodiode built in the laser or a photodiode provided on the outside and control for stabilizing the light emission amount is performed using a signal of the detection.

Processing of the APC is processing for controlling, mainly for each scanning, an amount of laser beams irradiated from the laser beam source to be a predetermined value. However, in an actual image forming apparatus, a factor that changes an amount of laser beams is present on an optical path from a laser beam source to a photoconductive drum. For example, since a transmittance of an optical element is different in a main scanning direction, an amount of laser beams in the main scanning direction on the photoconductive drum is not uniform. This nonuniformity of the amount of laser beams appears as density unevenness in a printed image.

The transmittance of the optical element is different depending on an angle of incident light. The transmittance is large when light is made incident along an optical axis of the optical element. The transmittance is small when light is made incident obliquely to the optical axis of the optical element. Therefore, an angle of incidence of a laser beam on an f-θ lens, which is an optical element used in image forming apparatuses and the like, is nearly vertical near the center of the f-θ lens and becomes more oblique toward the ends of the f-θ lens. Thus, a transmittance becomes smaller toward the ends of the f-θ lens.

FIG. 15 is a diagram showing the transmittance of the optical element in a position in the main scanning direction of light. The figure indicates that the transmittance is larger in an upper part of the ordinate and is smaller in a lower part of the ordinate. The transmittance is different depending on the positions in the main scanning direction. Thus, even if the amount of laser beams irradiated from the laser beam source is controlled to be constant by the APC processing, as shown in FIG. 16, an amount of laser beams in the main scanning direction on the photoconductive drum transmitted through the optical element is large in the center portion where the transmittance of the optical element is large and the amount of laser beams becomes smaller toward the ends of the optical element. The transmittance of the optical element is also different depending on a manufacturer or a type of the optical element.

As a conventional technique, there is a method of correcting the change in the amount of laser beams in the laser optical path and eliminating the density unevenness of the printed image (JP-A-11-112809). In the technique disclosed in JP-A-11-112809, light amount correction values corresponding to respective positions in the main scanning direction are set in a correction-value storing unit such as a memory in advance. Light-amount correcting means corrects an amount of laser beams using the light amount correction values and controls an amount of laser beams on a photoconductive drum to be constant.

In the technique disclosed in JP-A-11-112809, an operator changes the light amount correction values set in the correction-value storing unit and determines whether density unevenness is eliminated in a sample image outputted. The operator repeatedly executes this processing step to set a proper correction value.

### BRIEF SUMMARY OF THE INVENTION

An image forming apparatus according to a first aspect of the invention includes a scanning unit that deflects and scans a laser beam emitted from a laser beam source, an optical system that guides the laser beam onto a photoconductive drum, a storing unit that stores plural correction patterns that give a series of correction values for correcting an amount of laser beams in one scanning, a selecting unit that selects a correction group including at least two kinds of correction patterns out of the stored correction patterns, a switching unit that switches the at least two kinds of correction patterns belonging to the selected group at predetermined timing, a correcting unit that corrects, on the basis of the correction patterns switched by the switching unit, an amount of laser beams being scanned, and a printing unit that prints, on one medium, plural images formed on the photoconductive drum by laser beams corrected by the respective correction patterns.

An image forming method according to a second aspect of the invention is an image forming method for an image forming apparatus that scans and exposes a photoconductive drum with a laser beam emitted from a laser beam source and forms an image on this photoconductive drum, the image forming method including a storing step of storing plural correction patterns that give a series of correction values for correcting an amount of laser beams in one scanning, a selecting step of selecting a correction group including at least two kinds of correction patterns out of the stored correction patterns, a switching step of switching the at least two kinds of correction patterns belonging to the selected group at predetermined timing, a correcting step of correcting, on the basis of the correction patterns switched in the switching step, an amount of laser beams being scanned, and a printing step of printing, on one medium, plural images formed on the photoconductive drum by laser beams corrected by the respective correction patterns.

An image forming program according to a third aspect of the invention is an image forming program executed in an image forming apparatus that scans and exposes a photoconductive drum with a laser beam emitted from a laser beam source and forms an image on this photoconductive drum, the image forming program including a storing step of storing plural correction patterns that give a series of correction values for correcting an amount of laser beams in one scanning, a selecting step of selecting a correction group including at least two kinds of correction patterns out of the stored correction patterns, a switching step of switching the at least two kinds of correction patterns belonging to the selected group at predetermined timing, a correcting step of correcting, on the basis of the correction patterns switched in the switching step, an amount of laser beams being scanned, and a printing step of printing, on one medium, plural images formed on the photoconductive drum by laser beams corrected by the respective correction patterns.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a structure of an image forming apparatus;

FIG. 2 is a diagram showing structures of a control unit and a scanning and exposing unit of the image forming apparatus;

FIG. 3 is a diagram showing a structure of a circuit concerning correction of an amount of laser beams;

FIG. 4 is a timing chart of light amount correction in one scanning;

FIG. 5 is a timing chart of light amount correction in one scanning;

FIG. 6 is a diagram showing a structure of an instructing unit;

FIG. 7 is a flowchart showing a schematic procedure for printing a test pattern;

FIG. 8 is a flowchart showing a schematic procedure for printing a test pattern;

FIG. 9 is a diagram showing an example of plural density uneven images to be set as objects of a test pattern;

FIG. 10 is a diagram showing correction values for correcting density unevenness of the respective images;

FIG. 11 is a diagram showing examples of a sub-pattern;

FIG. 12 is a diagram showing a structure of a correction-value setting unit and connection of circuits related thereto;

FIG. 13 is a diagram showing a timing chart of a test pattern output;

FIG. 14 is a diagram showing a state in which density unevenness is corrected according to a test pattern;

FIG. 15 is a diagram showing a transmittance of an optical element in positions in a main scanning direction of light; and

FIG. 16 is a diagram showing an amount of laser beams in the main scanning direction on the surface of a photoconductive drum.

### DETAILED DESCRIPTION OF THE INVENTION

Embodiments of the present invention will be hereinafter explained with reference to the drawings.

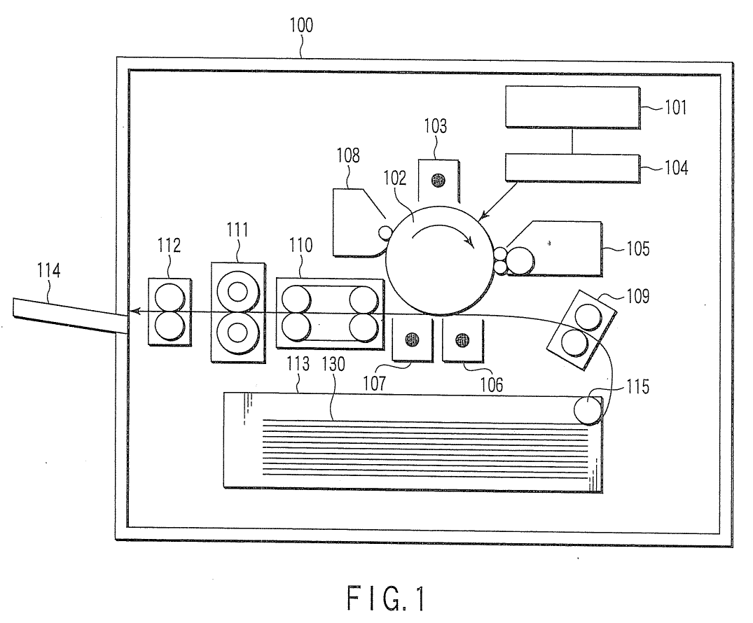

FIG. 1 is a diagram showing a structure of an image forming apparatus according to a first embodiment of the present invention.

An image forming apparatus 100 includes a control unit 101, a photoconductive drum 102, a charging device 103, a scanning and exposing unit 104, a developing device 105, a transfer charger 106, a peeling charger 107, a cleaner 108, a sheet feeding unit 109, a sheet conveying unit 110, a fixing device 111, a sheet discharging unit 112, and a sheet discharge tray 114.

The photoconductive drum 102 rotates in a sub-scanning direction (a circumferential direction of the photoconductive drum 102 indicated by an arrow). The charging device 103 is arranged near the photoconductive drum 102. The charging device 103 uniformly charges the surface of the photoconductive drum 102. The scanning and exposing unit 104 emits light and extinguishes light according to an image signal while scanning a semiconductor laser in the scanning and exposing unit 104. A laser beam emitted from this semiconductor laser is changed to light scanning in a main scanning direction (a rotation axis direction of the photoconductive drum 102) by a deflector such as a polygon mirror. The laser beam is irradiated on the photoconductive drum 102 by an optical system such as a lens. When the laser beam is irradiated on the charged photoconductive drum 102, a potential in an irradiated portion falls and an electrostatic latent image is formed.

The developing device 105 applies a developing agent on the photoconductive drum 102 to form a toner image on the photoconductive drum 102. On the other hand, a sheet cassette 113 is provided at the bottom of the image forming apparatus 100. A sheet feeding roller 115 separates sheets 130 in the sheet cassette 113 one by one and feeds the sheet 130 to the sheet feeding unit 109. The sheet feeding unit 109 feeds the sheet 130 to a transfer position of the photoconductive drum 102. The transfer charger 106 transfers the toner image onto the sheet 130 fed. The peeling charger 107 peels off the sheet 130 from the photoconductive drum 102.

The sheet 130 having the toner image transferred thereon is conveyed by the sheet conveying unit 110. The fixing device 111 fixes the toner image on the sheet 130. The sheet discharging unit 112 discharges the sheet 130 having the image printed thereon to the sheet discharge tray 114.

After the transfer of the toner image onto the sheet 130 is finished, a residual toner on the photoconductive drum 102 is removed by the cleaner 108. The photoconductive drum 102 returns to the initial state and comes into a state of standby for the next image formation.

By repeating process operations described above, an image forming operation is continuously performed.

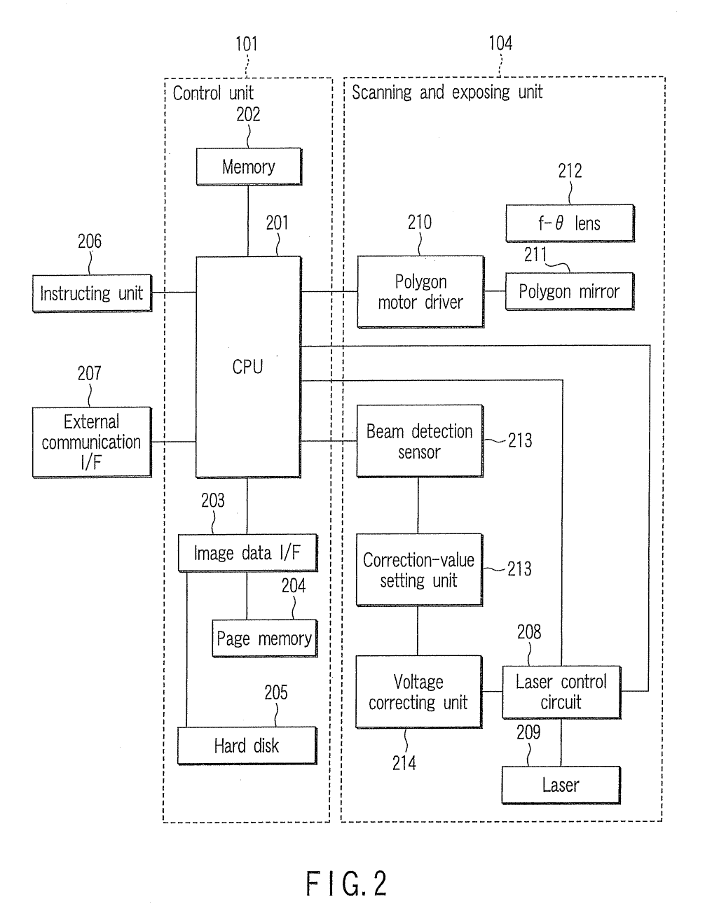

FIG. 2 is a diagram showing structures of the control unit 101 and the scanning and exposing unit 104 of the image forming apparatus 100.

The control unit 101 includes a CPU 201, a memory 202, an image data I/F 203, a page memory 204, and a hard disk 205.

An instructing unit 206 and an external communication I/F 207 are connected to the control unit 101 by signals. The instructing unit 206 includes operation members such as a touch panel and buttons. A communication interface for connecting a LAN cable, a USB cable, and the like is provided in the external communication I/F 207.

The scanning and exposing unit 104 includes a laser control circuit 208, a semiconductor laser (hereinafter referred to as “laser”) 209, a polygon motor driver 210, a polygon mirror 211, an f-θ lens 212, a beam detection sensor 213, a voltage correcting unit 214, and a correction-value setting unit 215.

The control unit 101 collectively controls the respective units of the image forming apparatus 100. In response to a request for printing of image data from the instructing unit 206 or the external communication I/F 207, the CPU 201 stores the image data requested to be printed in the page memory 204 or the hard disk 205 according to the necessity of printing of plural copies and the like. This processing is executed via the image data I/F 203. In this processing, the memory 202 functions as a temporary data storage buffer. The image data to be printed may be captured from a not-shown image scanning apparatus such as a scanner.

The instructing unit 206 designates a density correction value on the basis of operation of a user. The control unit 101 executes a density unevenness correcting operation on the basis of the density correction value designated. This operation will be described later.

The CPU 201 transmits the image data stored in the page memory 204 to the laser control circuit 208 in the scanning and exposing unit 104 through the image data I/F 203. The laser control circuit 208 turns on and off the laser 209 according to the image data transmitted. A laser beam emitted from the laser 209 is condensed by not-shown optical systems such as a collimator lens and a condenser lens and changed to scanning light by the polygon mirror 211 driven by the polygon motor driver 210. The laser beam is irradiated on the photoconductive drum 102, which is not shown in the figured, for each scanning line through the f-θ lens 212.

In the scanning and exposing unit 104, the beam detection sensor 213 arranged near the photoconductive drum 102 detects the scanning laser beam. A not-shown beam detection circuit generates, on the basis of a detection signal, a horizontal synchronizing signal serving as a reference of one scanning in the main scanning direction. The voltage correcting unit 214 applies a correction voltage for correcting an amount of laser beams in the main scanning direction to the laser control circuit 209. A value of this correction voltage is set in the correction-value setting unit 215 in advance.

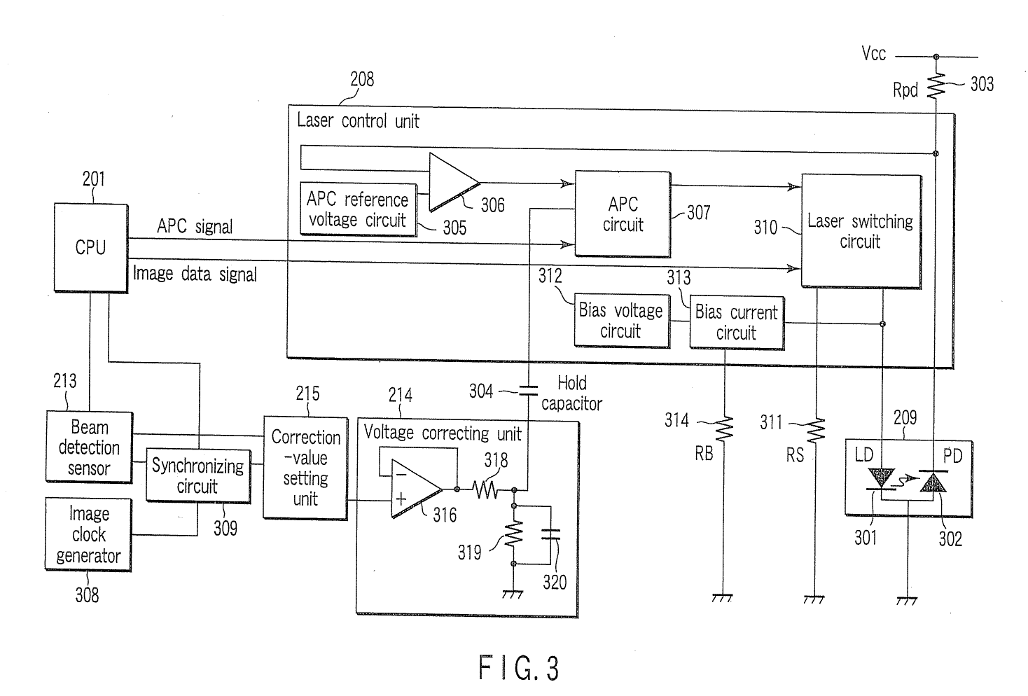

FIG. 3 is a diagram showing a structure of a circuit concerning correction of an amount of laser beams.

The above-mentioned laser beam amount stabilization control (APC) controlled by the laser control circuit 208 will be explained with reference to FIG. 3.

In the APC, an amount of laser beams of a laser beam source (LD) 301 is detected by a photodiode (PD) 302 built in the laser 209 or a photodiode (not shown) provided on the outside to cause the laser 209 to emit light with a desired amount of light according to a detection current of the photodiode 302.

Specifically, first, a predetermined laser driving current is supplied to the laser 209 to cause the laser beam source 301 to emit light. An amount of light emission of the laser beam source 301 is detected by the photodiode 302. This electric current detected is converted into a voltage by an adjusting resistor Rpd 303. A detected voltage Vm, which is a voltage value after the conversion, and a reference voltage Vref, which is a voltage value corresponding to a desired amount of light emission, are compared by a comparator 306. When the detected voltage Vm is larger than the reference voltage Vref, an electric charge of a hold capacitor 304 is discharged to reduce the amount of light emission of the laser beam source 301. When the detected voltage Vm is smaller than the reference voltage Vref, the electric charge of the hold capacitor 304 is charged to increase the amount of light emission of the laser beam source 301. In this way, the charge and the discharge of the hold capacitor 304 are controlled to adjust the detected voltage Vm to be equal to the reference voltage Vref. It is possible to keep the amount of laser beams of the laser beam source 301 constant according to this processing. The reference voltage Vref is supplied from an APC reference voltage circuit 305. However, the reference voltage Vref may be supplied from the outside.

This APC processing is performed when the APC circuit 307 is active. When the APC circuit is inactive, the comparator 306 is disconnected and, regardless of the detected voltage Vm and the reference voltage Vref, the laser beam source 301 is caused to emit light with a voltage equivalent to the electric charge of the hold capacitor 304 that is set when the APC circuit 307 is active.

Active and inactive of this APC circuit 307 are switched according to an APC signal inputted from the CPU 201. Timing of active and inactive of this APC circuit will be explained. Usually, the APC is activated when a scanning laser beam is in a portion outside an image area. When the scanning laser beam is in the image area, the APC is inactivated.

The scanned laser beam is detected by the beam detection sensor 213 provided outside the image area. A horizontal synchronizing signal serving as a reference of one scanning in the main scanning direction is generated on the basis of a signal of the detection. On the other hand, an image-clock generator 308 generates an image clock signal serving as a reference of an image data signal. A synchronizing circuit 309 synchronizes the image clock signal with this horizontal synchronizing signal. The CPU 201 counts the number of clocks of the image clock signal synchronized with the horizontal synchronizing signal using a counter in the CPU 201. The CPU 201 outputs, according to the count number, an APC signal for switching active and inactive to the APC circuit 307.

The laser control circuit 208 controls an amount of light of the laser beam source 301 to be constant using the APC and controls on and off of the laser beam source 301 according to the image data signal transmitted from the CPU 201. A laser switching circuit 310 executes the on and off control of the laser beam source 301.

A laser-driving-current limiter resistor (RS) 311 is connected to the laser switching circuit 310. By changing a resistance of this laser-driving-current limiter resistor (RS) 311, it is possible to set a maximum laser driving current and control a laser driving current not to be larger than a default value.

In order to improve a response characteristic of an on and off operation of the laser beam source 301, a bias current may be applied to the laser beam source 301 by a bias voltage circuit 312 and a bias current circuit 313. The bias current can be adjusted by changing a bias-current setting resistor (RB) 314. An offset current from a threshold of the laser beam source 301 may be set instead of the bias current.

In the APC processing explained above, the control of an amount of laser beams is performed for each scanning. However, in this APC processing, it is impossible to correct a change in an amount of light during image area scanning due to a difference in transmittance of a lens in one scanning or the like as described above.

Thus, during the image area scanning, the voltage correcting unit 214 corrects a change in an amount of laser beams. In other words, the voltage correcting unit 214 is connected to the hold capacitor 304 and a potential of the hold capacitor 304 is controlled to make it possible to correct an amount of light of the laser beam source 301. This takes into account the fact that it is possible to adjust an amount of laser beams with the potential of the hold capacitor 304.

Specifically, the voltage correcting unit 214 holds a correction voltage inputted from the correction-value setting unit 215 using a voltage follower 316. On the other hand, since this correction voltage is in an order of several V, the voltage correcting unit 214 divides the correction voltage using a resistor 318 and a resistor 319 to adjust the correction voltage to an order of several tens mV and applies the correction voltage to the hold capacitor 304. It is assumed that a correction voltage as a correction amount of an amount of laser beams is stored in the correction-value setting unit 215 in advance. A capacitor 320 may be connected in parallel to the resistor 319 to prevent noise from occurring easily when voltage correction is changed.

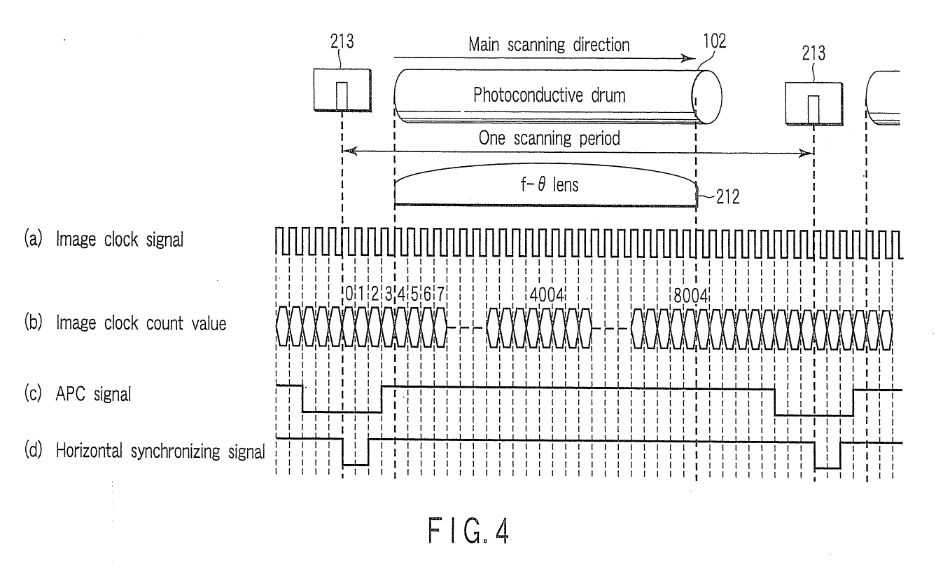

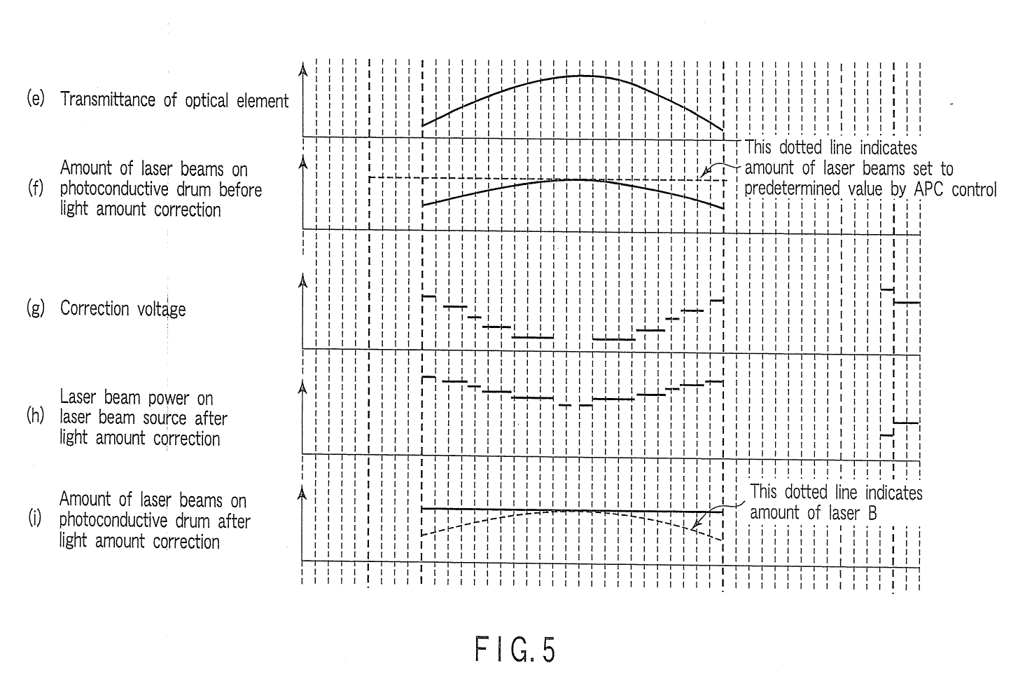

FIGS. 4 and 5 are timing charts of light amount correction processing in one scanning.

The abscissa of FIG. 4 indicates an elapsed time. The ordinate indicates an image clock signal (FIG. 4(a)), an image clock count value (FIG. 4(b)), APC signal timing (FIG. 4(c)), and horizontal synchronizing signal timing (FIG. 4(d)).

The abscissa of FIG. 5 indicates a position in a laser main scanning direction and the ordinate indicates a transmittance of an optical element (an f-θ lens) (FIG. 5(e)), an amount of laser beams on a photoconductive drum before light amount correction (FIG. 5(f)), a correction voltage applied by a voltage correcting unit (FIG. 5(g), an amount of laser beams on a laser beam source after the light amount correction (FIG. 5(h)), and an amount of laser beams on the photoconductive drum after the light amount correction (FIG. 5(i)).

The elapsed time on the abscissa of FIG. 4 corresponds to the position in the laser main scanning direction on the abscissa of FIG. 5.

The timing charts will be explained with reference to FIGS. 3 to 5.

The image-clock generator 308 generates an image clock signal serving as a reference of an image data signal shown in FIG. 4(a). The CPU 201 counts the number of clocks of this image clock signal with a horizontal synchronizing signal as a reference using the counter therein. An image clock count value is shown in FIG. 4(b). A position in the main scanning direction, i.e., a position on the photoconductive drum in the main scanning direction is determined by this clock counter number.

Therefore, the CPU 201 outputs, according to the clock count number, an APC signal for switching active and inactive to the APC circuit 307. A period of a LOW level in the APC signal in FIG. 4(c) indicates a state in which the APC is active.

When a scanned laser beam is detected by the beam detection sensor 213 while the APC of FIG. 4(c) is performed, a horizontal synchronizing signal shown in FIG. 4(d) is generated. The synchronizing circuit 309 synchronizes an image clock signal with this horizontal synchronizing signal for each scanning. In FIG. 4(d), as an example, the image clock signal is synchronized with the horizontal synchronizing signal at the rising edge in FIG. 4(d).

In the image area on the photoconductive drum 102, as shown in FIG. 5(e), a transmittance of the optical element is large in the center portion of the position in the main scanning direction and becomes smaller toward ends thereof. Therefore, as shown in FIG. 5(f), an amount of laser beams on the photoconductive drum 102 attenuates toward the ends compared with an amount of laser beams indicated by a dotted line, which is set to a predetermined value according to the APC control.

The correction voltage shown in FIG. 5(g) is applied by the voltage correcting unit 214 according to this attenuation of the amount of laser beams in the position in the main scanning direction. This application of the correction voltage is performed at timing corresponding to a clock counter number corresponding to the position in the main scanning direction.

FIG. 5(h) shows laser beam power after light amount correction. A correction voltage in the center portion where the amount of laser beams does not attenuate significantly is set to be small and a correction voltage is set larger toward the edges where the amount of laser beams attenuates significantly. In this way, the correction voltage is applied according to the position in the main scanning direction to make the amount of laser beams on the photoconductive drum 102 constant as shown in FIG. 5(i).

As the timing for changing the correction voltage in FIG. 5(g), the change does not need to be performed at each clock of the image clock signal and the correction voltage may be changed every several clocks. The correction voltage may be updated and outputted at an appropriate number of clocks.

A method of setting a correction value will be explained.

In the embodiment of the invention, plural test patterns are printed in accordance with plural kinds of density correction values set in advance. The user checks the plural test patterns printed and selects a test pattern with little density unevenness. Alternatively, the user designates sub-patterns that are test patterns for performing more detailed adjustment. Then, the user checks plural sub-patterns printed and selects a sub-pattern with little density unevenness. Consequently, it is possible to easily obtain a proper density correction value.

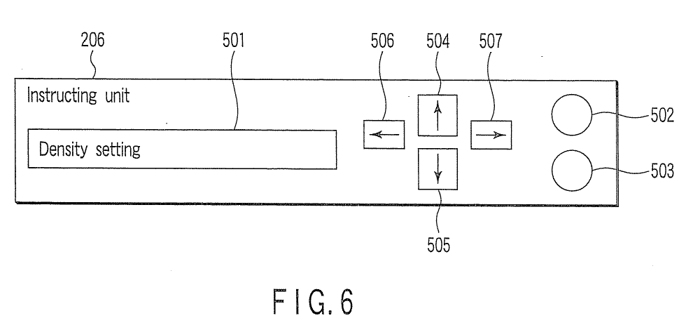

FIG. 6 is a diagram showing a structure of the instructing unit 206. The user performs various kinds of setting for printing test patterns from the instructing unit 206.

In the instructing unit 206, a display section 501, a determination button 502, a cancel button 503, an upper button 504, a lower button 505, a left button 506, and a right button 507 are provided.

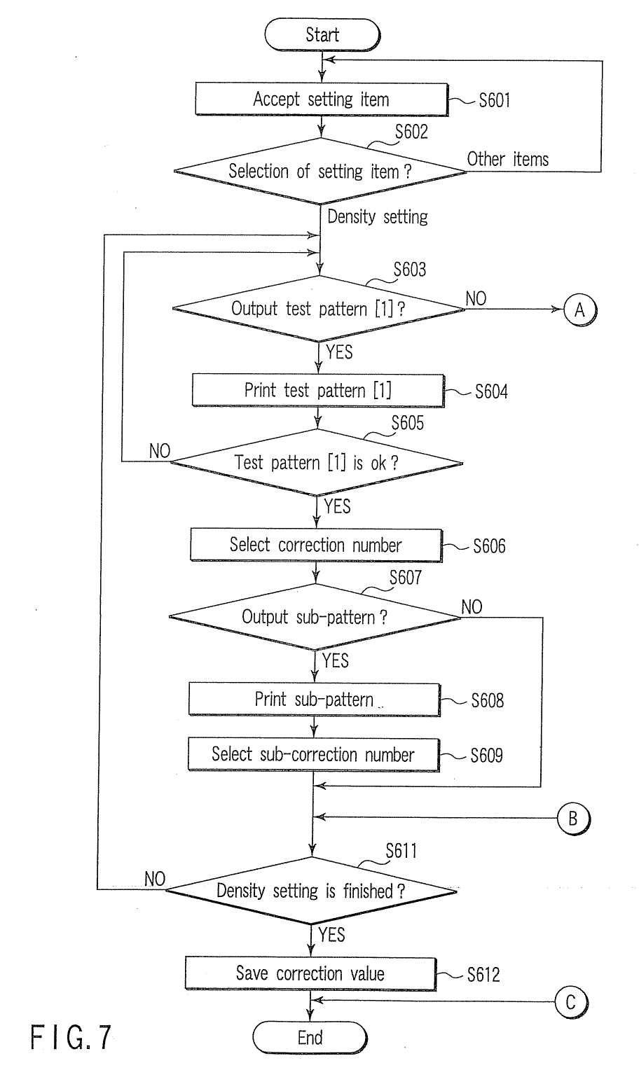

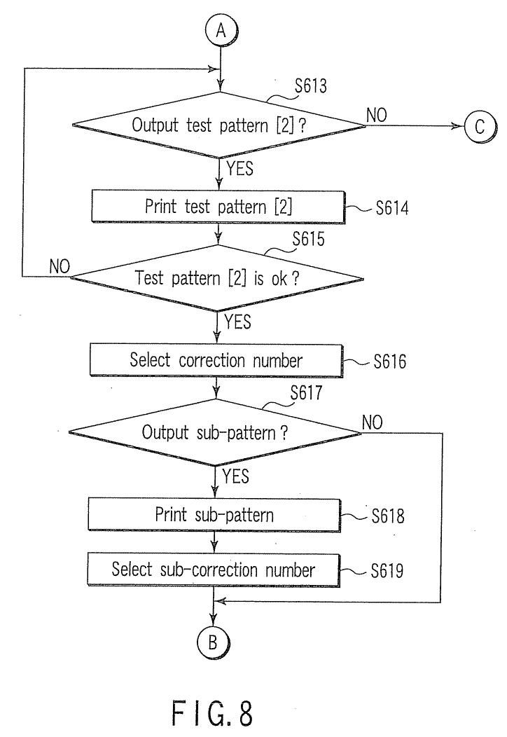

FIGS. 7 and 8 are flowcharts showing schematic procedures for printing a test pattern. Processing procedures shown in the figures are stored in the memory 202 and executed by the CPU 201.

In step S601, when the user presses the upper button 504 or the lower button 505, which is an item selection button, the CPU 201 brings the instructing unit 206 into a selected item accepting state. Subsequently, every time the user presses the upper button 504 or the lower button 505, the CPU 201 displays a new setting item. It is possible to select various setting items such as density setting and sheet setting according to this operation.

In the case of Yes in step S602, when the user displays “density setting”, which is a setting item, on the display section 501 and presses the determination button 502, the CPU 201 displays a number of a test pattern to be outputted. The user operates the upper button 504 or the lower button 505 to select the test pattern.

In the case of Yes in step S603, when the user presses the determination button 502 in a state in which “output test pattern [1]” is displayed on the display section 501, the CPU 201 prints a test pattern [1] in step S604.

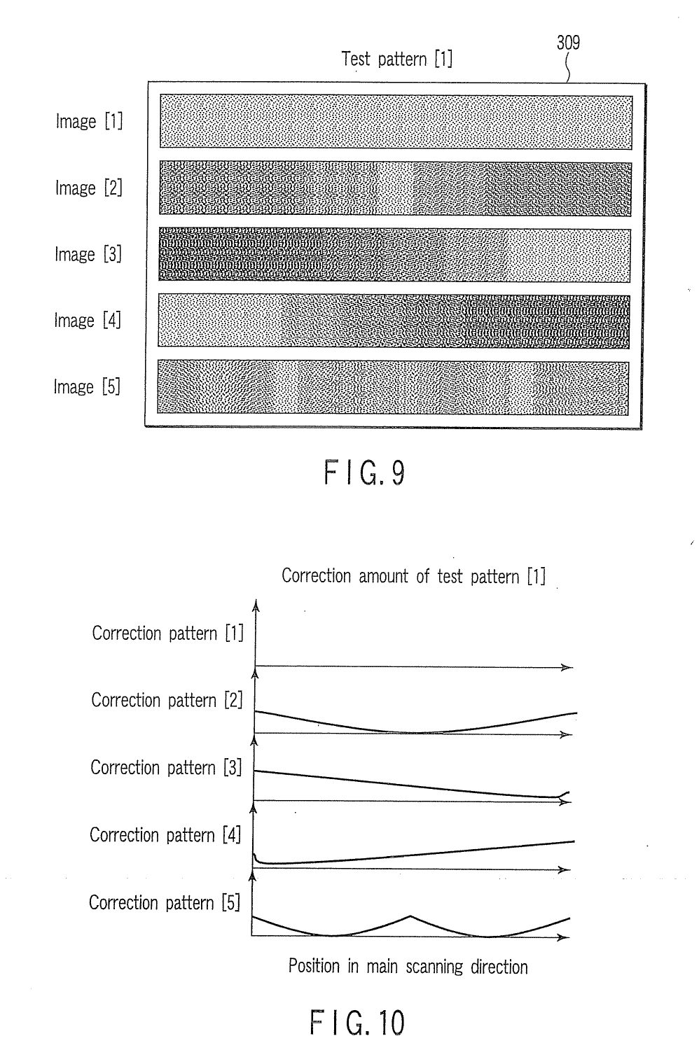

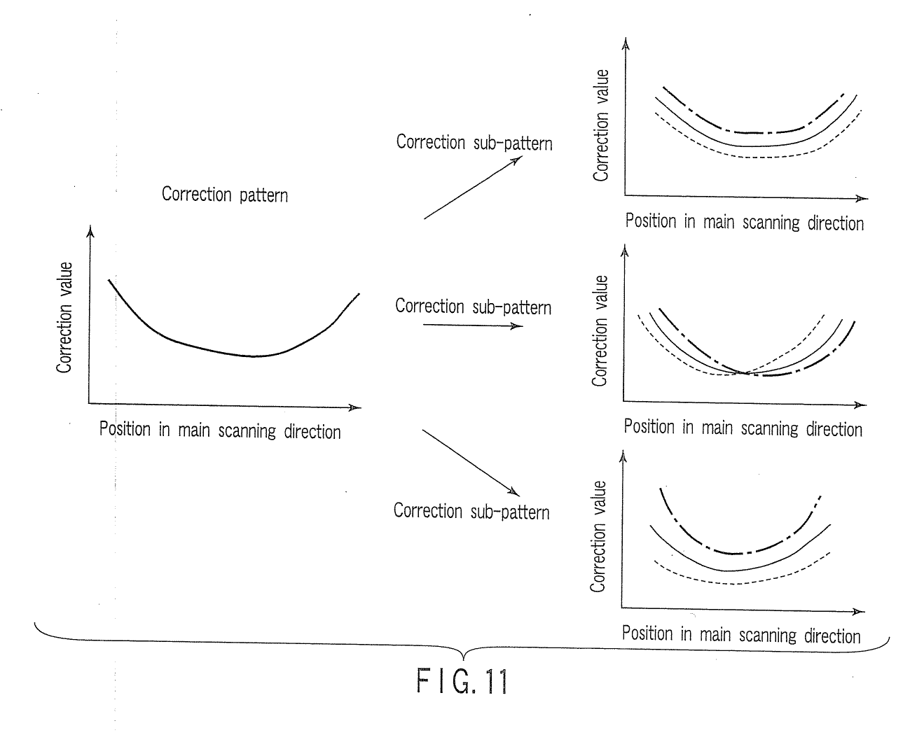

FIG. 9 shows an example of plural density uneven images to be set as objects of the test pattern [1]. FIG. 10 shows correction values for correcting density unevenness of the respective images. The test pattern and the correction values therefor will be explained with reference to FIGS. 9 and 10.

An image [1] in FIG. 9 indicates flat brightness. Since density unevenness does not occur, a correction pattern [1] in FIG. 10 corresponding to the image [1] is also flat and correction is not performed. An image [2] in FIG. 9 is bright in the center and dark at both the ends. In other words, the intensity of a laser beam is high in the center and the intensity of the laser beam is low at both the ends. Therefore, in a correction pattern [2] in FIG. 10 corresponding to the image [1], correction is performed to increase the intensity of the laser beam at both the ends in the main scanning direction.

An image [3] in FIG. 9 is bright at the right end and becomes darker toward the left end. In other words, the intensity of a laser beam is high at the right end and the intensity of the laser beam becomes lower toward the left end. Therefore, in a correction pattern [3] in FIG. 10 corresponding to the image [3], correction is performed to increase the intensity of the laser beam at the left end in the main scanning direction and decrease the-intensity of the laser beam toward the right end. An image [4] in FIG. 9 is dark at the right end and becomes brighter toward the left end. In other words, the intensity of a laser beam is low at the right end and the intensity of the laser beam increases toward the left end. Therefore, in a correction pattern [4] in FIG. 10 corresponding to the image [4], correction is performed to decrease the intensity of the laser beam at the left end in the main scanning direction and increase the intensity of laser beam toward the right end.

An image [5] in FIG. 9 is dark in the center and at both the ends and bright in portions between the center and both the ends. In other words, the intensity of a laser beam is low in the center and at both the ends and the intensity of the laser beam is high in the portions between the center and both the ends. Therefore, in a correction pattern [5] in FIG. 10 corresponding to the image [5], correction is performed to increase the intensity of the laser beam in the center and both the ends in the main scanning direction and decrease the intensity of the laser beam in the portions between the center and both the ends.

It is assumed that images of plural correction patterns, densities in the main scanning direction of which are independently different, included in the test pattern [1] and correction values corresponding to the respective correction pattern images are set in the memory 202 or the hard disk 205 in advance.

In the test pattern [1], five kinds of correction patterns from the correction pattern [1] to the correction pattern [5] are shown as examples of the correction patterns. The number of correction patterns is not limited as long as there are at least different two patterns.

The correction patterns are-not limited to the examples described above. A flat shape, a concave shape, a convex shape, a shape of an upward slant to the right, a shape of a downward slant to the right, a shape including a W shape, and a shape including an M shape may be used.

Referring back to FIG. 7, in step S605, the user discriminates density unevenness of the outputted test pattern [1] visually or using a densitometer.

In the case of Yes in step S605, i.e., when there is an image with little density unevenness in the outputted test pattern [1], in step S606, the user selects a correction pattern corresponding to the image. Since it is possible to compare plural images in this way, it is possible to easily discriminate an image with little density unevenness.

In the case of No in step S605, i.e., when there is no image with little density unevenness in the outputted test pattern [1], the CPU 201 returns to S603. The user selects a test pattern again. In selecting a test pattern, the user selects a test pattern with the left button 506 or the right button 507 and determines the test pattern with the determination button 502.

When the correction pattern with little density unevenness is selected in step S606, in step S607, “output sub-pattern” is displayed on the display section 501. The user selects whether a sub-pattern should be outputted. The sub-pattern is, for example, a pattern that is the same as the correction pattern selected in step S606 but has different density or a pattern that has a slightly different rate of change of density. FIG. 11 is a diagram showing examples of the sub-pattern. In the examples, when a correction pattern is represented by XY coordinates, correction patterns to be compared are in a relation of translation from each other along an X axis or a Y axis. Ratios of one correction value to other correction values in the same position in the main scanning direction are a fixed value. At least two or more correction patterns are set for an image of this sub-pattern.

In the case of Yes in step S607 in FIG. 7, i.e., when the user selects the sub-pattern output and presses the determination button 502, in step S608, the CPU 201 prints the sub-pattern. After the sub-pattern is outputted, the user discriminates density unevenness of images visually or using the densitometer. When there is an image with little density unevenness in the images outputted, in step S609, the user selects a correction sub-pattern corresponding to the image. Since it is possible to compare plural images in this way, it is possible to easily discriminate an image with little density unevenness.

On the other hand, in the case of No in step S607, i.e., when the user does not select the sub-pattern output, the correction pattern selected in step S606 is effective.

In step S611, “finish density setting” is displayed on the display section 501.

In the case of No in step S611, i.e., when the user presses the cancel button 503, the CPU 201 returns to step S603 and repeats the processing described above.

In the case of Yes in step S611, i.e., when the user presses the determination button 502, in step S612, the CPU 201 stores a correction value corresponding to the selected correction pattern or correction sub-pattern in the correction-value setting unit 215 and finishes the processing.

On the other hand, in the case of No in step S603, i.e., when the user presses the cancel button 503, “test pattern [2] output” is displayed on the display section 501. In the case of Yes in step S613 in FIG. 8, i.e., when the user presses the determination button 502 in a state in which “output test pattern [2]” is displayed on the display section 501, in step S604, the CPU 201 prints the test pattern [2].

Processing for the test pattern [2] in steps S614 to S619 is the same as the processing for the test pattern [1] in steps S604 to S609 described above. Thus, detailed explanations of the processing are omitted.

In this embodiment, the test pattern [1] and the test pattern [2] are used. However, in order to perform correction more accurately, kinds of test patterns may be increased. Alternatively, kinds of sub-patterns may be increased in the same manner.

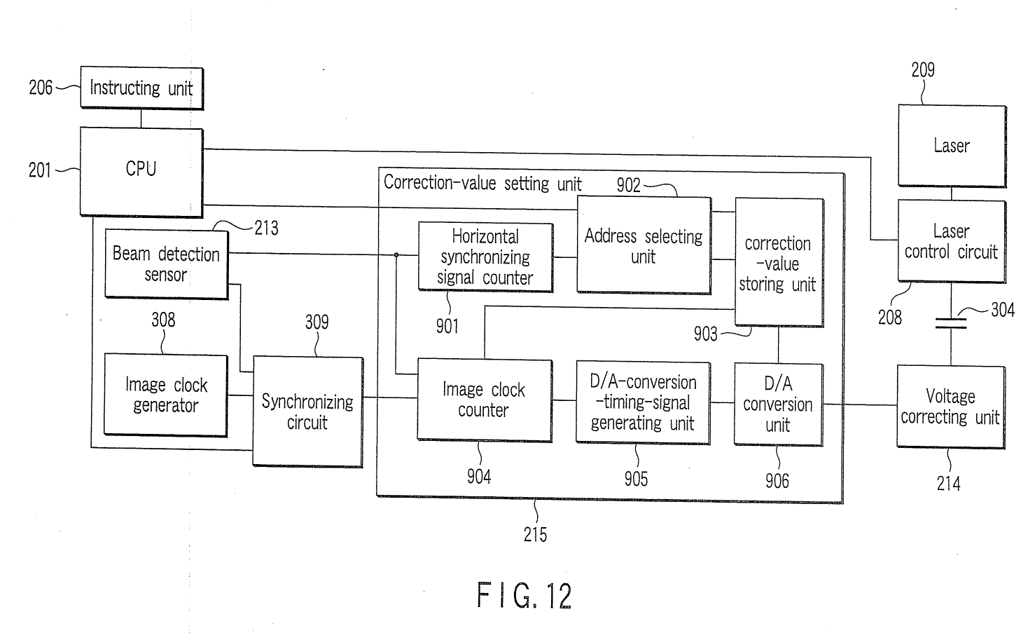

A structure of the correction-value setting unit 215 for realizing the above-mentioned correction value setting processing will be explained. FIG. 12 is a diagram showing the structure of the correction-value setting unit 215 and connection of circuits related thereto.

The correction-value setting unit 215 includes a horizontal synchronizing signal counter 901, an address selecting unit 902, a correction-value storing unit 903, an image clock counter 904, a digital/analog (DA)-conversion-timing-signal generating unit 905, and a DA conversion unit 906.

The horizontal synchronizing signal counter 901 counts horizontal synchronizing signals. The correction-value storing unit 903 stores plural patterns of time-series correction values in one horizontal scanning period. An address selecting unit 902 designates, in response to a count value of the horizontal synchronizing signals, an address in the correction-value storing unit 903 in which the correction values are stored. The image clock counter 904 counts image clock signals anew from input timing of the horizontal synchronizing signals. The DA-conversion-timing-signal generating unit 905 generates a timing signal for updating the correction values. The DA conversion unit 906 updates the correction values at designated timing, converts the correction values into analog signals, and holds the analog signals.

Operations of the correction-value setting unit 215 will be explained.

When the beam detection sensor 213 detects a scanned laser beam using a detection circuit therein, the beam detection sensor 213 generates a horizontal synchronizing signal serving as a reference of one scanning in the main scanning direction. On the other hand, the image clock generator 308 generates an image clock signal serving as a reference of an image data signal. The synchronizing circuit 309 synchronizes the image clock signal with this horizontal synchronizing signal. The image clock counter 904 in the correction-value setting unit 317 inputs the image clock signal synchronized with the horizontal synchronizing signal and counts the number of image clocks.

The horizontal synchronizing signal counter 901 in the correction-value setting unit 317 inputs horizontal synchronizing signals outputted from the beam detection sensor 213 and counts a number of the horizontal synchronizing signals. The address selecting unit 902 inputs a value of the count. The address selecting unit 902 selects an address of a correction value stored in the correction-value storing unit 903 on the basis of this counted number of the horizontal synchronizing signals. The address selecting unit 902 outputs the address to the correction-value storing unit 903. The correction-value storing unit 903 can output a correction value corresponding to a count value of the horizontal synchronizing signals to the DA conversion unit 906 on the basis of this address.

On the other hand, a counter value of the image clock counter 904 is also outputted to the correction-value storing unit 903. The correction-value storing unit 903 outputs a correction value in one scanning corresponding to the counter value of the image clock counter 904 to the DA conversion unit 906. The DA-conversion-timing-signal generating unit 905 outputs a DA conversion timing signal to the DA conversion unit 906 for each predetermined counter value of the image clock counter 904. According to this DA conversion timing signal, a correction value outputted from the DA changing unit is switched. The counter value of the image clock counter 904 is reset by the horizontal synchronizing signal from the beam detection sensor 213.

An analog voltage outputted from the DA conversion unit 906 is accumulated in the hold capacitor 304 through the voltage correcting unit 214. The laser control circuit 208 corrects and adjusts an amount of laser beams of the laser 209 according to a voltage at the hold capacitor 304.

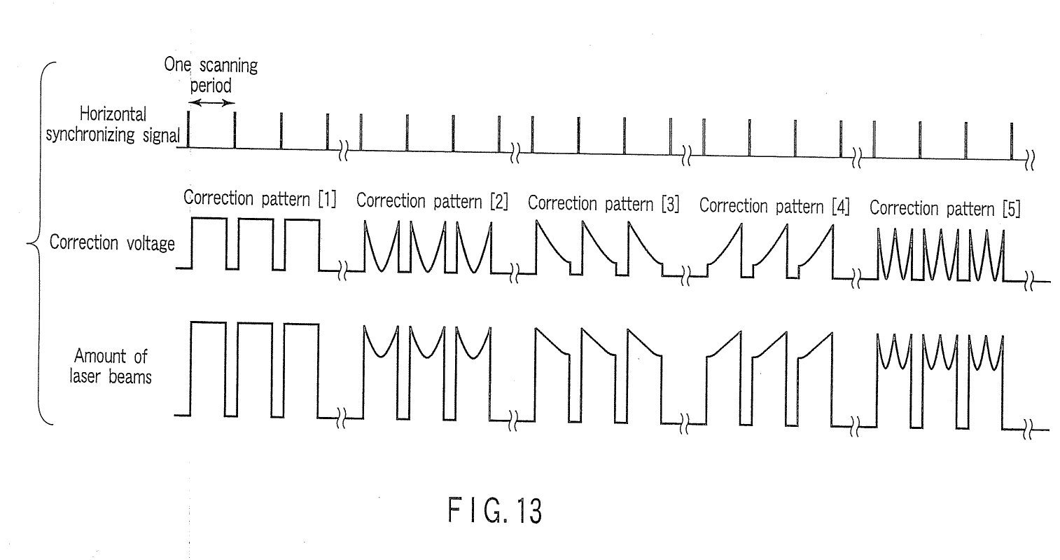

FIG. 13 is a diagram showing a timing chart of a test pattern output. A test pattern output operation will be explained with reference to FIGS. 12 and 13.

When the test pattern [1] is selected through the instructing unit 206, the CPU 201 instructs the address selecting unit 902 to designate five kinds of correction values included in the test pattern [1].

When the beam detection sensor 213 outputs a first horizontal synchronizing signal, a correction value of the correction pattern [1] is outputted according to the operation of the correction-value setting unit 215. A pattern of a correction voltage at this point is a flat shape. After that, the correction according to the correction pattern [1] is repeatedly continued every time a horizontal synchronizing signal is inputted. Therefore, a belt-like image according to the correction pattern [1] is printed.

When the horizontal synchronizing signals are generated a predetermined number of times, the address selecting unit 902 outputs an address where a correction value of the correction pattern [2] is stored. Consequently, the pattern of the correction voltage changes to a concave shape. After that, the correction according to the correction pattern [2] is repeatedly continued every time a horizontal synchronizing signal is inputted. Therefore, a belt-like image according to the correction pattern [2] is printed.

In the same manner, correction voltages according to the correction patterns [3] to [5] are outputted and belt-like images by the respective correction voltages are printed.

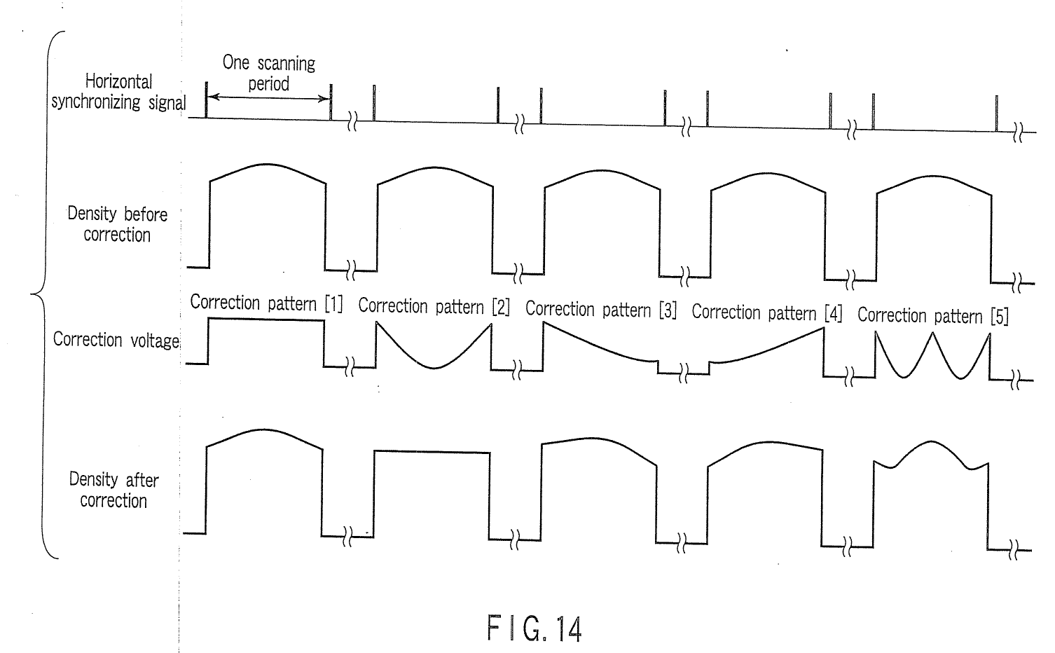

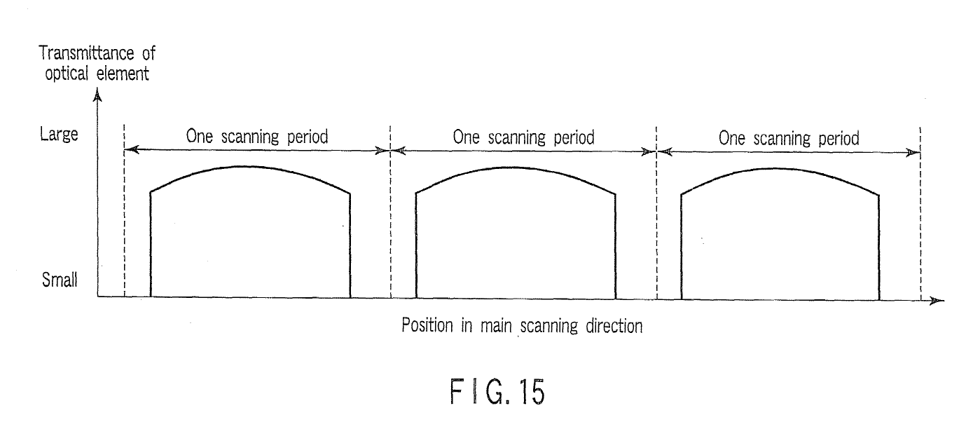

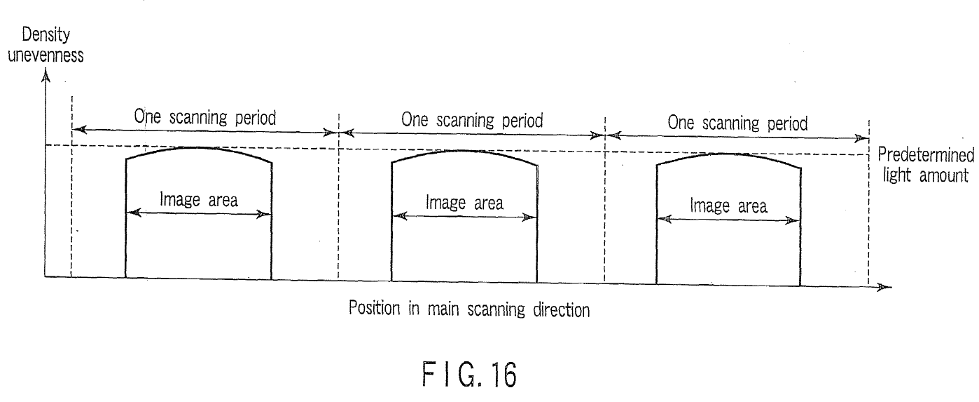

FIG. 14 is a diagram showing a state in which density unevenness is-corrected according to the test pattern [1].

When correction voltages of respective correction patterns shown in the middle section of FIG. 14 are given to density unevenness before correction shown in the upper section of FIG. 14, a density after the correction changes as shown in the lower section of FIG. 14.

The user can determine, by looking at images outputted, that the correction pattern [2] is effective for reducing the density unevenness compared with the other images.

As explained above, according to the image forming method according to this embodiment, it is possible to realize various effects.

In this embodiment, images according to the plural correction patterns are printed and provided.

Therefore, compared with a system for outputting correction patterns one by one and determining whether the correction pattern is effective, since the plural patterns that can be compared with one another are provided, it is possible to easily select an appropriate pattern.

Further, since it is possible to use a sub-pattern related to the correction pattern selected, it is possible to carefully eliminate density unevenness. Since plural images according to this sub-pattern are also printed, it is possible to easily select an appropriate pattern in the same manner as the effect described above.

As a result, it is possible to control an increase in product cost and easily select an appropriate pattern.

The respective functions explained in the above-mentioned embodiment may be constituted using hardware or may be realized by causing a computer to read a program describing the respective functions using software. The respective functions may be constituted by selecting the software or the hardware as appropriate.

It is also possible to realize the respective functions by causing the computer to read a program stored in a not-shown recording medium. A recording form of the recording medium in this embodiment may be any form as long as the recording medium is a recording medium that can record the program and is readable by the computer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a scanning unit configured to deflect and scan a laser beam emitted from a laser beam source;
an optical system configured to guide the laser beam onto a photoconductive drum;
a storing unit configured to store plural correction patterns that give a series of correction values for correcting an amount of laser beams in one scanning;
a selecting unit configured to select a correction group including at least two kinds of correction patterns out of the stored correction patterns;
a switching unit configured to switch the at least two kinds of correction patterns belonging to the selected group at predetermined timing;
a correcting unit configured to correct, on the basis of the correction patterns switched by the switching unit, an amount of laser beams being scanned; and
a printing unit configured to print, on one medium, plural images formed on the photoconductive drum by laser beams corrected by the respective correction patterns.

2. An image forming apparatus according to claim 1, wherein the switching unit switches, on the basis of a number of times of input of horizontal synchronizing signals, the at least two kinds of correction patterns belonging to the selected group.

3. An image forming apparatus according to claim 1, wherein the plural correction patterns belonging to the selected group have, when the correction patterns are represented in two dimensions with a position in a main scanning direction plotted on an X axis and a correction amount plotted on a Y axis, at least two of a flat shape, a concave shape, a convex shape, a shape of an upward slant to the right, a shape of a downward slant to the right, a shape including a W shape, and a shape including an M shape.

4. An image forming apparatus according to claim 1, further comprising a designating unit configured to designate one of the plural correction patterns belonging to the selected group, wherein the selecting unit selects a sub-group including new plural correction patterns associated with the designated correction pattern.

5. An image forming apparatus according to claim 4, wherein the correction patterns belonging to the selected sub-group are, when the correction patterns are represented in two dimensions with a position in a main scanning direction plotted on an X axis and a correction amount plotted on a Y axis, patterns shifted in an X axis direction or a Y axis direction from one another.

6. An image forming apparatus according to claim 4, wherein, in the correction patterns belonging to the selected sub-group, when the correction patterns are represented in two dimensions with a position in a main scanning direction plotted on an X axis and a correction amount plotted on a Y axis, ratios of one correction value to other correction values in a same position in the main scanning direction are the same.

7. An image forming method for an image forming apparatus that scans and exposes a photoconductive drum with a laser beam emitted from a laser beam source and forms an image on this photoconductive drum, the image forming method comprising the steps of:
storing plural correction patterns that give a series of correction values for correcting an amount of laser beams in one scanning;
selecting a correction group including at least two kinds of correction patterns out of the stored correction patterns;
switching the at least two kinds of correction patterns belonging to the selected group at predetermined timing;
correcting, on the basis of the correction patterns switched in the switching step, an amount of laser beams being scanned; and
printing, on one medium, plural images formed on the photoconductive drum by laser beams corrected by the respective correction patterns.

8. An image forming method according to claim 7, wherein, in the switching step, the at least two kinds of correction patterns belonging to the selected group are switched on the basis of a number of times of input of horizontal synchronizing signals.

9. An image forming method according to claim 7, wherein the plural correction patterns belonging to the selected group have, when the correction patterns are represented in two dimensions with a position in a main scanning direction plotted on an X axis and a correction amount plotted on a Y axis, at least two of a flat shape, a concave shape, a convex shape, a shape of an upward slant to the right, a shape of a downward slant to the right, a shape including a W shape, and a shape including an M shape.

10. An image forming method according to claim 7, further comprising the step of designating one of the plural correction patterns belonging to the selected group, wherein
in the selecting step, a sub-group including new plural correction patterns associated with the designated correction pattern is selected.

11. An image forming method according to claim 10, wherein the correction patterns belonging to the selected sub-group are, when the correction patterns are represented in two dimensions with a position in a main scanning direction plotted on an X axis and a correction amount plotted on a Y axis, patterns shifted in an X axis direction or a Y axis direction from one another.

12. An image forming method according to claim 10, wherein, in the correction patterns belonging to the selected sub-group, when the correction patterns are represented in two dimensions with a position in a main scanning direction plotted on an X axis and a correction amount plotted on a Y axis, ratios of one correction value to other correction values in a same position in the main scanning direction are the same.

13. An image forming program executed in an image forming apparatus that scans and exposes a photoconductive drum with a laser beam emitted from a laser beam source and forms an image on this photoconductive drum, the image forming program comprising:
a storing step of storing plural correction patterns that give a series of correction values for correcting an amount of laser beams in one scanning;
a selecting step of selecting a correction group including at least two kinds of correction patterns out of the stored correction patterns;
a switching step of switching the at least two kinds of correction patterns belonging to the selected group at predetermined timing;
a correcting step of correcting, on the basis of the correction patterns switched in the switching step, an amount of laser beams being scanned; and
a printing step of printing, on one medium, plural images formed on the photoconductive drum by laser beams corrected by the respective correction patterns.

14. An image forming program according to claim 13, wherein, in the switching step, the at least two kinds of correction patterns belonging to the selected group are switched on the basis of a number of times of input of horizontal synchronizing signals.

15. An image forming program according to claim 13, wherein the plural correction patterns belonging to the selected group have, when the correction patterns are represented in two dimensions with a position in a main scanning direction plotted on an X axis and a correction amount plotted on a Y axis, at least two of a flat shape, a concave shape, a convex shape, a shape of an upward slant to the right, a shape of a downward slant to the right, a shape including a W shape, and a shape including an M shape.

16. An image forming program according to claim 13, further comprising a designating step of designating one of the plural correction patterns belonging to the selected group, wherein
in the selecting step, a sub-group including new plural correction patterns associated with the designated correction pattern is selected.

17. An image forming program according to claim 16, wherein the correction patterns belonging to the selected sub-group are, when the correction patterns are represented in two dimensions with a position in a main scanning direction plotted on an X axis and a correction amount plotted on a Y axis, patterns shifted in an X axis direction or a Y axis direction from one another.

18. An image forming program according to claim 16, wherein, in the correction patterns belonging to the selected sub-group, when the correction patterns are represented in two dimensions with a position in a main scanning direction plotted on an X axis and a correction amount plotted on a Y axis, ratios of one correction value to other correction values in a same position in the main scanning direction are the same.
